(19) United States
(12) Patent Application Publication
(10) Pub. No.: US 2003/0015824 A1
(43) Pub. Date: Jan. 23, 2003

(54) Injection-molded, mineral-filled articles and processes for making the same

(76) Inventors: Alan H. Forbes, Victor, NY (US); Wen Pao Wu, Pittsford, NY (US)

Correspondence Address: JENKENS & GILCHRIST, P.C., 225 WEST WASHINGTON, SUITE 2600, CHICAGO, IL, 60606, US

(21) Appl. No.: 10/227,977

(22) Filed: Aug. 26, 2002

Related U.S. Application Data
(62) Division of application No. 09/781,612, filed on Feb. 12, 2001.

(51) Int. Cl. B29C 45/00; A21C 5/00

(52) U.S. Cl. 264/328.18; 30/115

(57) ABSTRACT

A process for preparing an injection-molded cutlery The process includes providing a mixture of a filler and a polymer The mixture comprises from about 30 to about 70 wt. % filler and from about 30 to about 70 wt. % polymer The mixture is heated to its melting temperature and then injected into a mold The mixture is cooled so as to form the cutlery The cutlery is ejected from the mold

### FIELD OF THE INVENTION

The present invention relates generally to polymeric articles and, more specifically, to injection-molded, mineral-filled cutlery and processes for making the same

### BACKGROUND OF THE INVENTION

Polymeric cutlery has been used for many years. Polymeric cutlery, such as spoons, forks, and knives, are typically made from injection-molded polystyrene or polypropylene Since such cutlery is often disposed of after one use, it needs to be inexpensive to manufacture Customers often desire that the cutlery closely resemble quality metallic flatware in terms of strength, rigidity, and mass

The existing polymers used in forming polymeric cutlery, however, have several drawbacks One drawback is the long process time required since a mold of the polymer needs a large amount of time to cool before removing the cutlery from the mold. This cooling time causes an increase in both the total process time and the economic costs for making the cutlery Three main reasons exist for the long cooling time First, because of the generally high specific heat of the polymers, it takes a long time for the polymers to cool to a temperature where the cutlery is sufficiently molded Second, the polymers used to form the cutlery are not very strong and, therefore, cannot be ejected from the mold until the cutlery is almost completely hardened Third, the low thermal conductivity of the polymer requires a long cooling time

Another drawback is that cutlery made of polystyrene or polypropylene does not have the desired rigidity of quality metallic flatware The lack of rigidity causes the cutlery to bend when lifting, which may cause customer dissatisfaction Such dissatisfaction may include food falling off the cutlery onto the apparel of the customer

Also, the polymeric cutlery often lacks sufficient strength as compared to quality metallic flatware. The lack of strength may cause the cutlery to break during use, causing frustration among customers Another drawback is that polymeric cutlery is very light and, thus, does not have as much “mass” as quality metallic flatware. Since consumers often equate heavier flatware with higher quality, a higher “mass” is also desired for plastic cutlery.

Therefore, a need exists for polymeric cutlery which is less expensive to make and has greater rigidity, strength, and mass than the polymeric cutlery currently in use.

### SUMMARY OF THE INVENTION

According to one embodiment of the present invention, a process for preparing an injection-molded cutlery includes providing a mixture of a filler and a polymer The mixture comprises from about 30 to about 70 wt. % filler and from about 30 to about 70 wt. % polymer The mixture is heated to its appropriate melting temperature and injected into a mold After cooling the mixture to form the cutlery, the cutlery is then ejected from the mold The cooling time of the process for forming the cutlery of the present invention is decreased, resulting in increasing productivity and economical savings. The cutlery of the present invention also exhibits greater rigidity, strength, and mass than existing polymeric cutlery.

According to another embodiment of the present invention, the mixture is made by mixing a filler with a polymer in an injection molding machine having a twin screw extruder

### BRIEF DESCRIPTION OF THE DRAWINGS

The foregoing and other advantages of the invention will become apparent upon reading the following detailed description and upon reference to the drawings

FIG. 1 is a flow chart depicting a process for making the cutlery according to one embodiment of the present invention.

FIG. 2 is a graph depicting a dynamic modulus test of a neat polystyrene and a filled polystyrene FIG. 3 is a graph depicting a dynamic modulus test of a neat polypropylene and a filled polypropylene

While the invention is susceptible to various modifications and alternative forms, a specific process has been shown by way of example in the drawings and will be described in detail herein It should be understood, however, that the invention is not intended to be limited to the particular forms disclosed. Rather, the invention is to cover all modifications, equivalents, and alternatives falling within the spirit and scope of the invention as defined by the appended claims

### DESCRIPTION OF ILLUSTRATIVE EMBODIMENTS

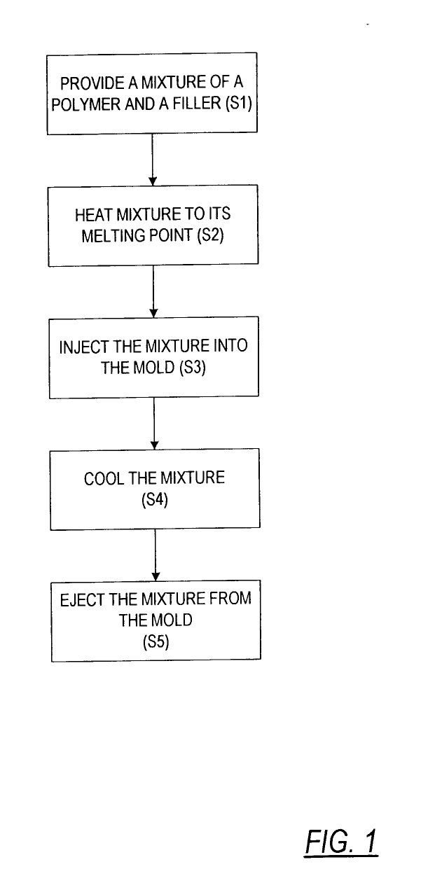

Referring now to FIG. 1, the process for making cutlery of the present invention will be described Cutlery is defined herein as including spoons, knives, forks, and a combination of the above, such as sporks As shown in step S I, a mixture is provided comprising a filler and a polymer The mixture generally comprises from about 30 to about 70 wt % filler and from about 30 to about 70 wt. % polymer. More specifically, the mixture is from about 40 to about 60 wt % filler and from about 40 to about 60 wt % polymer. The filler may be talc, mica, calcium carbonate, barium sulfate, stone dust, or combinations thereof In one embodiment, the filler is either talc, calcium carbonate, or the combination thereof The filler is advantageous because it provides mass to the cutlery, so as to make it feel more like quality metallic flatware The filler also reduces the process time associated with forming the cutlery.

The polymer may be made from polyesters, polyolefins, alkenyl aromatic polymers, or combinations thereof. For example, the polymer may be made from two different polyolefins One example of a polyester is a linear polymer which has the ester group (—CO—O) repeated along the chain. A polyolefin may be defined as a polymer based on olefin monomers such as polyethylenes and polypropelenes An example of an alkenyl aromatic polymer is a polymer possessing benzene rings either in side groups or in the main backbone chain Some of the polymers contemplated for use in the mixture include polyethylene terephthalates, crystallized polyethylene terephthalates (CPET), polyethylenes, high density polyethylenes, low density polyethylenes, polypropylenes, polystyrenes, and high impact polystyrenes (HIPS). It is also contemplated that other polymers may be used in the mixture Because of rigidity and cost issues at this time, the preferred polymers are polystyrene, high impact polystyrene, homopolymer polypropylene, or copolymer polypropylene

The mixtures of the present invention may be pre-compounded at the appropriate ratios For example, one commercially available pre-compounded talc-filled polypropylene is available from Spartech Corporation under the product number EP5140M B1 This makes the production of the filled polymer easier since there is no need to mix the filler and the polymer. Purchasing the pre-compounded filled polymer at the desired weight percentage, however, may not be cost effective Alternatively, the filler and polymer may be (a) provided separately and compounded in-line with a twin screw extruder as discussed below, or (b) purchased pre-compounded at different, more cost effective, weight percentages and then blended with neat polymers in-line In one embodiment, the filler and polymer are provided separately and then melted and mixed until they are a homogenous compound in a twin screw extruder before transferring in the mixture to an injection molding machine In another embodiment, it is contemplated that extrusion blending may be used. In this embodiment, a highly filled precompounded polymer, for example, comprising from about 50 to about 85 wt. % filler and from about 15 to about 50 wt % polymer, is diluted with a neat polymer and blended prior to injection molding The dilution causes the end product to be from about 30 to about 70 wt % filler and from about 30 to about 70 wt % polymer It is also contemplated that the filler and polymer may be mixed in other manners

As shown in step S2 of FIG. 1, the mixture is heated to its appropriate melting temperature. Depending on the fillers and polymers used, this melting temperature will vary For example, a mixture of talc and polystyrene is heated to a temperature ranging from about 400 to about 550° F. The specific heats of the fillers are generally lower than the specific heat of the polymers. Having a lower specific heat reduces time and energy required to melt the mixture Thus, the mixtures of fillers/polymers of the present invention generally require less energy to melt, which results in faster processing times than existing processes Of course, faster processing times result in lower costs associated with the manufacturing steps for making the cutlery

Once the mixture is melted, it is then injected into the mold as depicted in step S3 In one embodiment of the present invention, a reciprocating screw-type injection molding machine is used in step S3 The reciprocating screw-type injection molding machine, according to one embodiment, has a cavity and a rotating screw at one end of the cavity and an opening at the opposing end The rotating screw moves in a first direction in response to increased pressure in the cavity As the screw moves in the first direction, the mixture is then drawn into the cavity of the injection molding machine Once the mixture is in the cavity, the screw is then moved in a second direction generally opposite to the first direction, resulting in ejection of the mixture from the injection molding machine and into a mold of the desired shape (i.e., spoon, knife, or fork) A detailed description of injection molding may be found, for example, in chapter five of the SPI Plastics Engineering Handbook, Fifth Edition, edited by Michael L Berins (1991)

To form the cutlery in its desired shape, the mixture is cooled in step S4 of FIG. 1 During cooling, the mixture hardens into its desired shape The cooling time for the polymeric cutlery of the present invention varies depending on the mixture, but is generally from about 8 to about 12 seconds Existing processes, on the other hand, are typically from 10 to 14 seconds.

The final step, as shown in step S5 of FIG. 1, is ejecting the cutlery from the mold once it is cooled The cutlery may be ejected earlier than existing polymeric cutlery for numerous reasons First, the cutlery possesses greater strength, as determined by a Dynamic Mechanical Analyzer, or DMA Second, the flexural modulus, or rigidity, of the cutlery of the present invention is greater, generally from about 300,000 to about 900,000 psi and, more specifically, from about 400,000 to about 800,000 psi, as determined by ASTM D790

### EXAMPLES

The following examples are presented to demonstrate the flexural modulus, or rigidity, as determined by ASTM D790, of various polymer and filled polymer cutlery

In each of the examples below, unfilled or filled polymer systems were compounded by feeding the polymer and filler (when applicable, in the approximate proportion) into a Leistritz 34 mm co-rotating twin screw extruder. The mixture is then extruded into a sheet form, of approximately 0 020 inches in thickness, through a flat die Actual weight percent filler was determined by performing an ash test or by calculation from the composite density with the following equation

wt % filler=[d_{f}×(d_{c}−dₚ)]/[d_{c}×(d_{f}−dₚ)]×100

where d_{f}=density of filler

d_{c}=density of the composite

dₚ=density of polymer

Flexural moduli were determined from these sheets per ASTM D790 Table 1 depicts polypropylene filled with talc and calcium carbonate (CaCO₃) Table 2 depicts HIPS and CPET with both fillers Five specimens of each sample were tested in both the Machine Direction (MD) and the Transverse Direction (TD) The results were then averaged and rounded to the nearest thousand

TABLE 1
Flexural Properties Of Unfilled And Filled Polypropylene

| | Unfilled | | | | |
|---|---|---|---|---|---|
| | System | Mineral Filled Systems | | | |
| polymer^{a} | PP | PP | PP | PP | PP |
| filler^{b} | None | talc | talc | CaCO₃ | CaCO₃ |
| wt % filler | — | 41.3 | 60.1 | 39.7 | 72.6 |
| flexural modulus^{c}, Kpsi | | | | | |
| MD | 197 | 557 | 875 | 389 | 599 |
| TD | 202 | 554 | 867 | 402 | 543 |
| average | 199 | 555 | 871 | 396 | 571 |
| % increase over unfilled | — | 179% | 337% | 98% | 186% |
| system | | | | | |
| specific heat^{d} @ 25° C., | 1.70 | 1.38 | 1.17 | N/A^{e} | N/A^{e} |
| J/g-° C. | | | | | |

^{a}PP homopolymer, melt flow ratio (MFR) = 0.8
^{b}talc Luzenac JetFil 575C, CaCO₃. Omya Omyacard FT
^{c}ASTM D790
^{d}Measured from extruded sheet with a Perkin Elmer DSC-7
^{e}Not tested or calculated

TABLE 2
Flexural Properties Of Unfilled And Filled HIPS And CPET

| | HIPS | | | CPET | | |
|---|---|---|---|---|---|---|
| | Unfilled | Filled | Filled | Unfilled | Filled | Filled |
| Polymer^{f} | HIPS | HIPS | HIPS | CPET | CPET | CPET |
| Filler^{g} | None | talc | CaCO₃ | None | talc | CaCO₃ |
| wt % filler | — | 33.6 | 35.5 | — | 34.4 | 45.1 |
| flexural | | | | | | |
| modulus^{h}, Kpsi | | | | | | |
| MD | 371 | 820 | 485 | N/Aⁱ | 1031 | 790 |
| TD | 355 | 604 | 457 | N/Aⁱ | 865 | 767 |
| average | 363 | 712 | 471 | 450^{j} | 948 | 778 |
| % increase over | — | 96% | 30% | — | 111% | 73% |
| unfilled | | | | | | |

^{f}HIPS Nova 5620, MFR = 3.0, CPET Eastman Chemical Eastpack 12822
^{g}talc Luzenac JetFil 575C, CaCO₃ Polar Mineral 8103
^{h}ASTM D790
ⁱNot tested or calculated
^{j}Resin supplier data

Flexural modulus is measured in psi As shown in Table 1, filled polymers have a flexural modulus of 30 to 340% higher than neat polymers, depending upon the filler and the polymer used

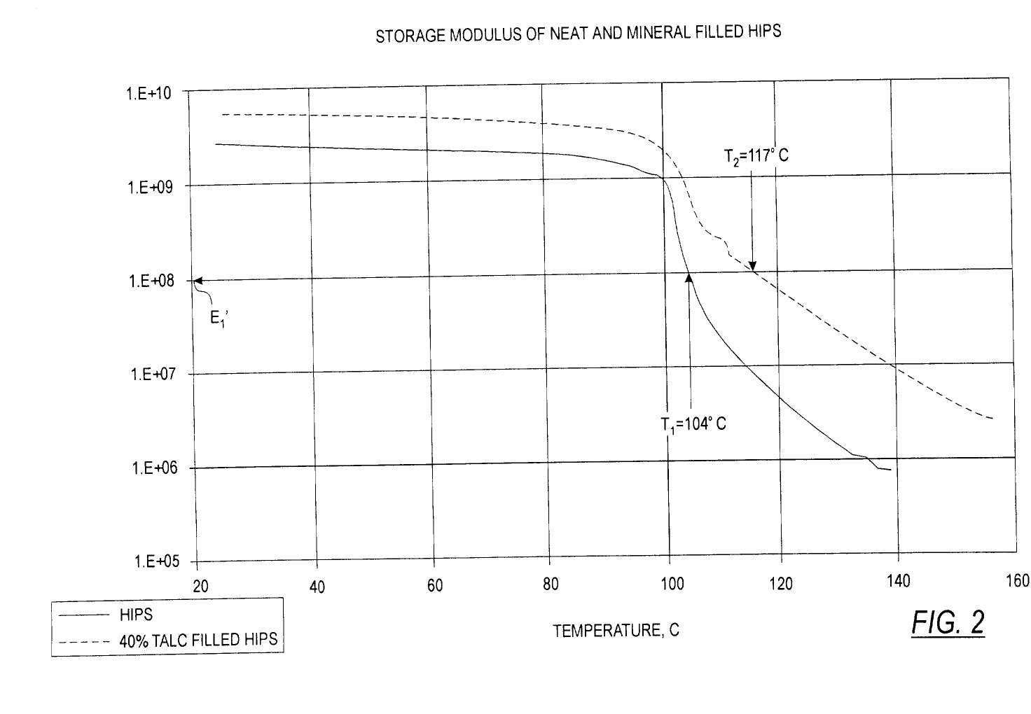

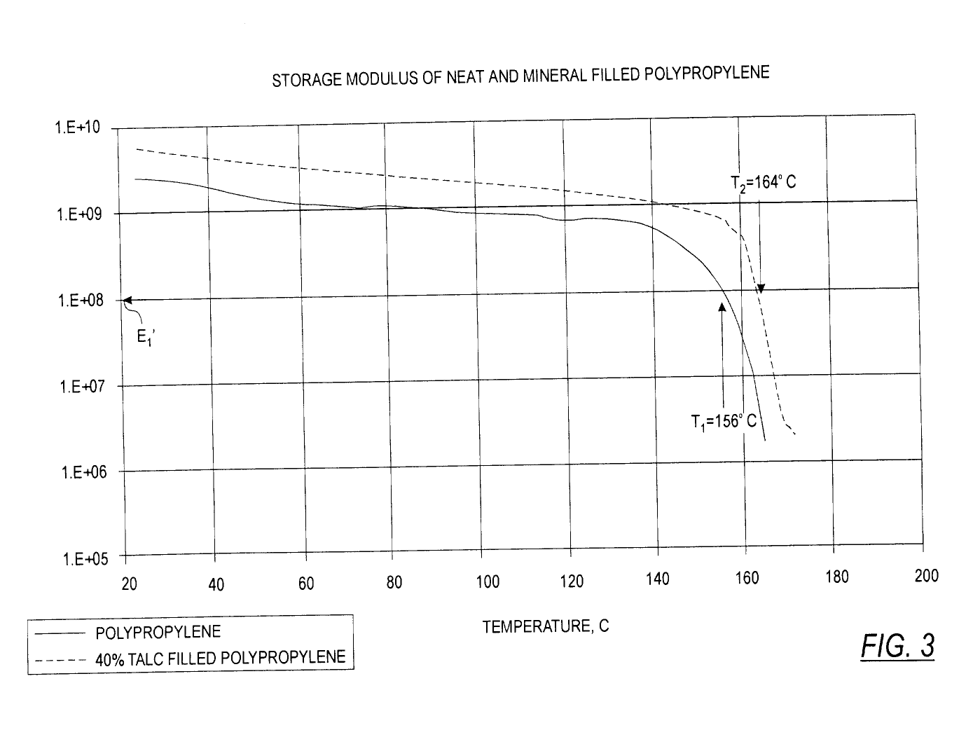

FIGS. 2 and 3 are graphs depicting the dynamic storage modulus at various temperatures. The solid lines represent a neat polymer without any fillers, while the dotted lines represent a filled polymer of the present invention The polymers and composites were tested using ASTM D5418-99, using duplicate samples of each The test samples were 50 mm wide by 55 mm long by 0 5 mm thick E′₁ represents the minimum dynamic modulus for demolding a compound FIG. 2 shows a neat polystyrene and a filled polystyrene, while FIG. 3 shows a neat polypropylene and a filled polypropylene

As shown in FIGS. 2 and 3, the filled polymer exhibits greater dynamic storage modulus at all temperatures For the neat polymers, E′₁ is reached at temperature T₁ As shown in both FIGS. 2 and 3, however, the filled polymers reach E′₁ at a higher temperature T₂ For example, as shown in FIG. 2, if the minimum dynamic modulus is 10⁸, the demolding temperature of polystyrene is reached at 104° C. Filled polystyrene cutlery, however, is capable of being demolded at 117° C. This relationship holds true in reference to polypropylene, as well. In FIG. 3, using the same minimum dynamic modulus, the polypropylene cutlery reaches the demolding temperature at 156° C. Filled polypropylene, however, reaches the demolding temperature at 164° C. Thus, these filled polymers are demolded at higher temperatures, decreasing processing times

While the present invention has been described with reference to one or more particular embodiments, those skilled in the art will recognize that many changes may be made thereto without departing from the spirit and scope of the present invention Each of these embodiments and obvious variations thereof is contemplated as falling within the spirit and scope of the claimed invention, which is set forth in the following claims

What is claimed is:

1. A process for preparing an injection-molded cutlery, the process comprising
providing a mixture of a filler and a polymer, wherein the mixture is from about 30 to about 70 wt % filler and from about 30 to about 70 wt % polymer;
heating the mixture to its appropriate melting temperature,
injecting the mixture into a mold,
cooling the mixture to form the cutlery, and
ejecting the cutlery from the mold.

2. The process according to claim 1, further comprising providing an injection molding machine having a cavity and a rotating screw, and wherein injecting the mixture into the mold includes drawing the mixture into the cavity by moving the rotating screw in a first direction and wherein injecting the mixture into the mold includes moving the rotating screw in a second direction generally opposite to the first direction

3 The process according to claim 1, wherein the polymer is selected from the group consisting of a polyester, a polyolefin, and an alkenyl aromatic polymer

4. The process according to claim 3, wherein the polymer is a polyethylene terephthalate

5 The process according to claim 3, wherein the polymer is a crystallized polyethylene terephthalate

6 The process according to claim 3, wherein the polymer is a polyethylene

7 The process according to claim 6, wherein the polymer is a high density polyethylene

8 The process according to claim 3, wherein the polymer is a homopolymer polypropylene.

9. The process according to claim 3, wherein the polymer is an ethylene-propylene copolymer

10. The process according to claim 3, wherein the polymer is a polystyrene.

11. The process according to claim 10, wherein the polymer is a high impact polystyrene.

12. The process according to claim 1, wherein the filler is talc, mica, calcium carbonate, barium sulfate, stone dust, or combinations thereof

13 The process according to claim 12, wherein the filler is talc, calcium carbonate, or a combination thereof

14 The cutlery made by the process of claim 1

15 The process according to claim 1, wherein providing a mixture includes providing a polymer, providing a filler, and providing an injection molding machine having a compounding extruder, and mixing the polymer and the filler in the twin screw extruder so as to provide the mixture.

16 The process according to claim 1, wherein providing a mixture includes providing a pre-compounded mixture comprising from about 50 to about 85 wt. % filler and from about 15 to about 50 wt. % polymer

17 The process according to claim 16, further comprising mixing neat polymer with the pre-compounded mixture prior to heating the mixture to its appropriate melting temperature.

18 The process according to claim 1, wherein the flexural modulus of the cutlery is at least 50% greater than that of its neat polymer as determined by ASTM D790

19. The process according to claim 1, wherein the flexural modulus of the cutlery is at least 150% greater than that of its neat polymer as determined by ASTM D790

20 The process according to claim 1, wherein the mixture is from about 40 to about 60 wt. % filler and from about 40 to about 60 wt % polymer

21 The process according to claim 20, wherein the filler is talc and the polymer is one of polystyrene and high impact polystyrene

22. The process according to claim 1, wherein ejecting the cutlery from the mold occurs at a temperature T₂ which is greater than a temperature T₁ at which cutlery formed of neat polymer is ejected from the mold.

23 A process for forming cutlery, comprising
providing a mixture from about 30 to about 70 wt. % filler and from about 30 to about 70 wt % polymer,
providing an injection-molded machine with a cavity and a rotating screw,
heating the mixture in the injection molding machine to an appropriate temperature to melt the mixture;
moving the rotating screw in a first direction so as to draw the mixture into the cavity of the injection molding machine,
moving the rotating screw in a direction generally opposite to the first direction to inject the mixture into a mold from the cavity,
cooling the mixture to an appropriate temperature in the mold so as to form the cutlery,
opening the mold, and
ejecting the cutlery from the mold

24 The process according to claim 23, wherein the mixture is from about 40 to about 60 wt % filler and from about 40 to about 60 wt % polymer

25 The process according to claim 24, wherein the filler is one of talc and calcium carbonate and the polymer is one of polystyrene, polypropylene and high impact polystyrene

26 A cutlery comprising a filler and a polymeric material, the cutlery including from about 30 to about 70 wt % filler and from about 30 to about 70 wt % polymer, wherein the filler is talc, mica, calcium carbonate, barium sulfate, stone dust, or a combination thereof

27. The process according to claim 26, wherein the mixture is from about 40 to about 60 wt % filler and from about 40 to about 60 wt % polymer

28 The process according to claim 27, wherein the filler is one of talc and calcium carbonate and the polymer is one of polystyrene, high impact polystyrene, and polypropylene
